(19) United States
(12) Patent Application Publication
(10) Pub. No.: US 2015/0016226 A1
(43) Pub. Date: Jan. 15, 2015

(54) BEAMFORMER, BEAMFORMING METHOD, ULTRASONIC IMAGING APPARATUS, AND CONTROL METHOD OF ULTRASONIC IMAGING APPARATUS

(71) Applicants: SAMSUNG ELECTRONICS CO., LTD., Suwon-si (KR); Industry Academic Cooperation Foundation, Hallym University, Chuncheon-si (KR)

(72) Inventors: Kyu Hong KIM, Seoul (KR); Sung Chan PARK, Suwon-si (KR); Su Hyun PARK, Hwaseong-si (KR); Joo Young KANG, Yongin-si (KR); Jung Ho KIM, Yongin-si (KR); Moo Ho BAE, Seoul (KR)

(73) Assignees: SAMSUNG ELECTRONICS CO., LTD., Suwon-si (KR); Industry Academic Cooperation Foundation, Hallym University, Chuncheon-si (KR)

(21) Appl. No.: 14/329,325

(22) Filed: Jul. 11, 2014

(30) Foreign Application Priority Data
Jul. 11, 2013 (KR) 10-2013-0081652

(51) Int. Cl. G10K 11/26

(52) U.S. Cl. CPC G10K 11/26
USPC 367/138

(57) ABSTRACT

Disclosed herein is a beamformer that performs beamforming, including a weight computation processor configured to compute a covariance of a conversion signal which is obtainable by converting an input signal using at least one conversion function, approximate the computed covariance to a Toeplitz matrix form, and compute a conversion signal weight that is a weight for the conversion signal based on the approximation result, and a synthesizer configured to generate an output signal using the conversion signal weight computed by the weight computation processor.

### CROSS-REFERENCE TO RELATED APPLICATION

This application claims priority from Korean Patent Application No. 10-2013-0081652, filed on Jul. 11, 2013 in the Korean Intellectual Property Office, the disclosure of which is incorporated herein by reference in its entirety.

### BACKGROUND

1. Field

Exemplary embodiments relate to a beamformer and a beamforming method.

2. Description of the Related Art

An ultrasonic imaging apparatus uses ultrasonic wave characteristics and obtains tomographic images of a subject, such as, for example, various tissues inside a human body. Because the ultrasonic imaging apparatus is not associated with risks such as exposure to X-rays, can display images in real time, and is relatively cheaper and smaller than other imaging apparatuses such as a magnetic resonance imaging apparatus, the ultrasonic imaging apparatus is widely used in various fields, for example, in the medical field.

The ultrasonic imaging apparatus collects ultrasonic waves which are delivered from a target area inside the subject, and then generates an ultrasound image based on information which relates to the collected ultrasonic waves. The ultrasonic wave delivered from the target area inside the subject may include an echo ultrasonic wave that is a reflection wave of an ultrasonic wave emitted from the ultrasonic imaging apparatus, or an ultrasonic wave generated by a laser that is emitted to the target area by a photoacoustic imaging apparatus.

The ultrasonic imaging apparatus performs beamforming of data of a plurality of channels of collected ultrasound signals, and then restores an original image by using, for example, a point spread function, generates an appropriate ultrasound image for recognizing an internal structure of the subject, and displays the result to a user.

### SUMMARY

Therefore, it is an aspect of one or more exemplary embodiments to provide a beamformer, a beamforming method, an ultrasonic imaging apparatus using the beamformer, and a control method which is executable by the ultrasonic imaging apparatus, which can reduce computational complexity required for beamforming of the beamforming apparatus, decrease resource usage of the beamforming apparatus, and improve a computation speed in various beamforming apparatuses that perform beamforming operations such as the ultrasonic imaging apparatus.

The exemplary embodiments have been made in view of the above-mentioned problems, and the exemplary embodiments provide a beamformer, an ultrasonic imaging apparatus using the beamformer, a beamforming method using the beamformer, and a control method which is executable by the ultrasonic imaging apparatus using the beamformer.

In accordance with one aspect of one or more exemplary embodiments, a beamformer includes a weight computation processor configured to compute a covariance matrix of a conversion signal which is obtainable by converting an input signal using at least one conversion function, to approximate the computed covariance matrix to a Toeplitz matrix form, and to compute an input signal weight which includes at least one from among a direct weight for the input signal and a conversion signal weight that is a weight for the conversion signal based on a result of the approximating; and a synthesizer configured to generate an output signal using the computed input signal weight.

The weight computation processor may be further configured to compute an approximate matrix by using a result of the approximating the computed covariance matrix of the conversion signal to the Toeplitz matrix form by using an equation which is expressible as:

$${\tilde{R}}_{1 , m} = \frac{1}{L - m} {\sum }_{l = 1}^{L - m} {R}_{1 , l , l + m} \qquad Equation 1$$

In Equation 1, m=0, 1, . . . , L−1, R_{1,l,l+m} represents an element in an l-th row and m-th column of a covariance R of the conversion signal, \tilde{R}_{1,m} is a value of an m-th diagonal of the approximate matrix, and L is a number of rows of the covariance R of the conversion signal.

After an inversion of the computed approximate matrix is obtained, the weight computation processor may be further configured to compute the conversion signal weight by using the inversion of the obtained approximate matrix. In this case, the weight computation processor may be further configured to compute the conversion signal weight for the conversion signal by using an equation which is expressible as:

$$β = \frac{{\tilde{R}}_{1}^{- 1} {v}_{1}}{{v}_{1}^{H} {\tilde{R}}_{1}^{- 1} {v}_{1}} \qquad Equation 2$$

In Equation 2, β is a conversion signal weight for the conversion signal, \tilde{R}₁ is the approximate matrix, and v₁ is a steering vector.

In accordance with another aspect of one or more exemplary embodiments, an ultrasonic imaging apparatus includes an ultrasound probe configured to emit an ultrasonic wave to a subject, to receive at least one ultrasound signal which is reflected from the subject, and to output the ultrasound signal by converting the received at least one ultrasonic wave, and a beamformer configured to generate a conversion ultrasound signal by converting the ultrasound signal by using at least one conversion function, computing a covariance of the conversion ultrasound signal, approximating the computed covariance to a Toeplitz matrix form, computing an input signal weight which includes at least one from among a direct weight for the ultrasound signal and a conversion signal weight that is a weight for the conversion signal based on a result of the approximating, and then performing beamforming using the computed input signal weight.

In accordance with still another aspect of one or more exemplary embodiments, a beamforming method includes: generating a conversion signal that is obtainable by converting an input signal using at least one conversion function, computing a covariance of the conversion signal, approximating the computed covariance to a Toeplitz matrix form, computing an input signal weight which includes at least one from among a direct weight for the input signal and a conversion signal weight for the conversion signal based on a result of the approximating, and generating an output signal using the computed input signal weight.

In accordance with yet another aspect of one or more exemplary embodiments, a control method of the ultrasonic imaging apparatus includes: an ultrasound signal obtaining operation in which an ultrasonic wave is emitted toward a target area, an echo ultrasonic wave reflected at the target area is received, and the received echo ultrasonic wave is converted to obtain an ultrasound signal; a time-difference correcting operation in which a time difference between the obtained ultrasound signals is corrected and a time-difference corrected ultrasound signal is generated; a signal conversion operation in which the time-difference corrected ultrasound signal is converted; a covariance computing operation in which a covariance for the conversion ultrasound signal is computed; an approximating operation in which the computed covariance is approximated to a Toeplitz matrix form; a weight computation operation in which an ultrasound signal weight for the ultrasound signal or a conversion ultrasound signal weight for the conversion ultrasound signal is computed based on the approximation result, and a beamformed ultrasound signal generating operation in which a beamformed ultrasound signal is generated using the conversion ultrasound signal weight.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a diagram which illustrates a configuration of a beamformer, according to an exemplary embodiment;

FIG. 2 is a block diagram which illustrates a weight computation unit, according to an exemplary embodiment;

FIG. 3 is a diagram which illustrates a configuration of a beamformer, according to another exemplary embodiment;

FIGS. 4 and 5 are diagrams which illustrate a configuration of a beamformer, according to still another exemplary embodiment;

FIG. 6 is a flowchart which illustrates a weight computation method, according to an exemplary embodiment;

FIG. 7 is a flowchart which illustrates a beamforming method, according to an exemplary embodiment;

FIG. 8 is a perspective view which illustrates an ultrasonic imaging apparatus, according to an exemplary embodiment;

FIG. 9 is a diagram which illustrates a configuration of the ultrasonic imaging apparatus, according to an exemplary embodiment;

FIG. 10 is a plan view which illustrates an ultrasound probe unit, according to an exemplary embodiment;

FIG. 11 is a diagram which illustrates a configuration of a beamforming unit of the ultrasonic imaging apparatus;

FIGS. 12 and 13 are diagrams which illustrate a configuration of a beamforming unit, according to another exemplary embodiment; and

FIG. 14 is a flowchart which illustrates an ultrasonic imaging apparatus control method, according to an exemplary embodiment.

### DETAILED DESCRIPTION

Reference will now be made in detail to exemplary embodiments of the present invention, examples of which are illustrated in the accompanying drawings, wherein like reference numerals refer to like elements throughout.

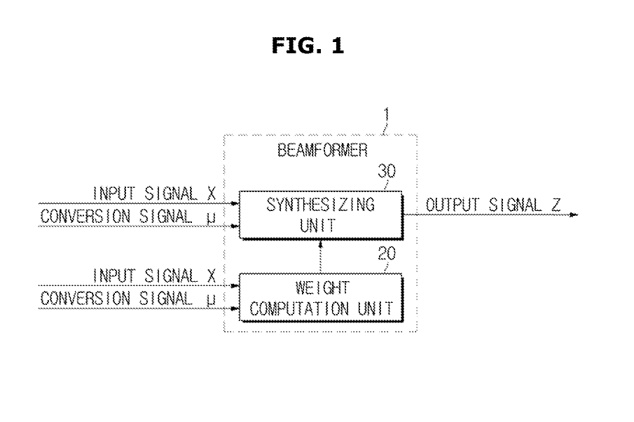

Hereinafter, a beamformer and a beamforming method according to an exemplary embodiment will be described with reference to FIGS. 1 to 7.

FIG. 1 is a diagram which illustrates a configuration of weight computation in the beamformer, according to the exemplary embodiment.

A beamformer 1 performs beamforming using signals of a plurality of channels, such as, for example, a sound wave signal and/or an ultrasound signal, in order to estimate a size of a wave that is delivered from a specific target area.

Beamforming is a method in which a plurality of signals that are delivered to a target area and reflections that are received therefrom are focused to generate a single output signal. More specifically, when signals of a plurality of channels, for example, a plurality of ultrasound signals, are input from the target area, a time difference between respective pairs of input signals of each respective channel are corrected, and a weighted sum of each signal for which a time difference has been corrected is computed with a predetermined weight, that is, a beamforming coefficient, such that a signal of a specific channel is emphasized or a signal of a different channel is relatively attenuated in order to focus signals of the plurality of channels.

Depending on characteristics of the beamforming coefficient used for beamforming, beamforming may be classified as being one of a data-independent beamforming method and an adaptive beamforming (data-dependent beamforming) method. In the data-independent beamforming, beamforming is performed such that a weight which is determined independently with respect to an input signal is applied to the input signal. Conversely, in the adaptive beamforming, an optimal weight is separately computed based on an input ultrasound signal, and then beamforming is performed using the separately computed weight. Therefore, the weight used for the adaptive beamforming is dependent on the input signal.

The beamformer 1 that performs such beamforming may be used in, for example, an ultrasonic imaging apparatus, a sonar, and/or a radar, or may also be used in, for example, an array microphone and/or an array speaker in the field of acoustic signal processing. Moreover, the beamformer 1 can be also used in an array antenna.

As illustrated in FIG. 1, more specifically, the beamformer 1 may include a weight computation unit (also referred to herein as a “weight computation processor”) 20, and a synthesizing unit (also referred to herein as a “synthesizer”) 30.

The weight computation unit 20 uses an input signal (x) and/or a conversion signal (u) into which the input signal (x) is converted, and computes at least one weight to be applied to the input signal (x) and/or the conversion signal (u), that is, an input signal weight (ω) and/or a conversion signal weight (β). The computed input signal weight (ω) and/or the conversion signal weight (β) may be used as a weight that is applied to each signal for beamforming by the beamformer 1, that is, a beamforming coefficient. The weight computation unit 20 computes the input signal weight (ω) and/or the conversion signal weight (β), and then delivers the computed input signal weight (ω) and/or the conversion signal weight (β) to the synthesizing unit 30. Therefore, it is possible to perform a weighted sum of the input signal (x) and/or the conversion signal (u) and the input signal weight (ω) and/or the conversion signal weight (β).

The conversion signal (u) is a signal into which the input signal (x) is converted by using a predetermined conversion function (V). The conversion signal (u) may be computed by using the following Equation 1.

u=V^{H}x Equation 1

In Equation 1, x represents an input signal, and V represents a predetermined conversion function. u represents a conversion signal that is obtainable by converting the input signal using the predetermined conversion function (V).

More specifically, an input signal x and a conversion signal u may be represented as an (A×B) matrix. In this aspect, A and B are natural numbers. In particular, if B is equal to 1, the input signal x and the conversion signal u are represented as an (A×1) matrix. This can be expressed as the following Equations 2 and 3.

$$\begin{matrix}x = ( \begin{matrix}{x}_{1} \\ {x}_{2} \\ ¨ \\ {x}_{m}\end{matrix} ) & Equation 2 \\ u = ( \begin{matrix}{u}_{1} \\ {u}_{2} \\ ¨ \\ {u}_{n}\end{matrix} ) & Equation 3\end{matrix}$$

In Equations 2 and 3, m and n are positive integers. When the input signal x and the conversion signal u are expressed as Equations 2 and 3, the input signal x has m dimensions, and the conversion signal u has n dimensions. The input signal x may include a plurality of input signals which are input via a plurality of channels. In particular, the input signal x may include a set of input signals of a plurality of channels.

Moreover, similarly, the conversion signal u may also include a set of conversion signals of a plurality of channels that are output to a plurality of channels. In Equation 2, each element in a matrix of the input signal x, that is, x₁ to xₘ, represents an input signal of each channel. Likewise, in Equation 3, each element of the conversion signal u, that is, u₁ to uₙ, represents a conversion signal that is obtainable by converting the input signal of each channel. Each element of the matrix of the input signal x and the conversion signal u may also be represented as a predetermined matrix, for example, a (1×a) matrix.

The conversion function (V) used for input signal conversion may include at least one basis vector and/or a combination of a plurality of basis vectors. Depending on specific implementations of embodiments, the plurality of basis vectors configuring the conversion function (V) may be orthogonal to each other, and more specifically, the plurality of basis vectors may include an eigenvector and/or a Fourier basis vector.

For example, the conversion function (V) may include at least one basis vector and/or a combination of a plurality of basis vectors which are obtainable by performing a principal component analysis for an optimal value of the input signal weight (ω) based on minimum variance.

The conversion function (V) may be determined by settings which are predefined in a system device using the beamformer 1 or by user selection. The conversion function (V) may be determined as, for example, a combination of a plurality of basis vectors that are selected, by a user, from among a plurality of basis vectors which are stored in a separate conversion function database.

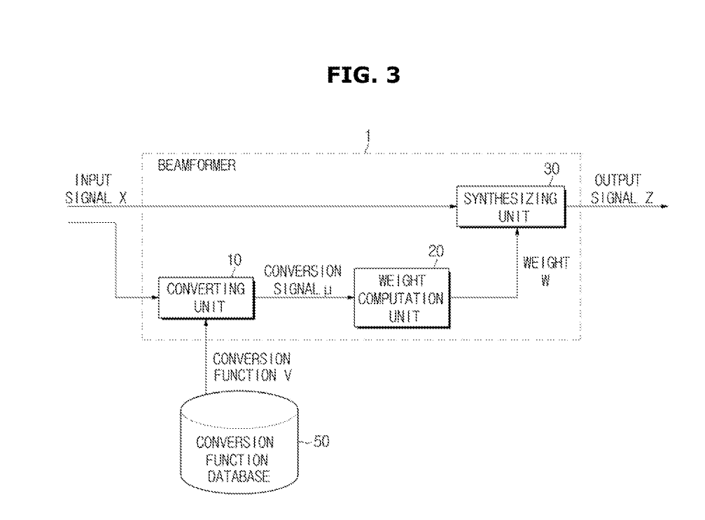

Depending on specific implementations of embodiments, based on various input signals (x) that can be obtained empirically or theoretically, at least one conversion function (V) is separately computed in advance, at least one conversion function (V) that can be assigned or applied to various input signals (x) is separately defined in advance, and then the at least one computed conversion function (V) may be stored in a separate conversion function database (e.g., database 50 as illustrated in FIG. 3). Then, the beamformer 1 may select at least one conversion function (V) from among at least one conversion function (V) stored in the conversion function database 50 based on the input signal (x), and assign the selected conversion function (V) to Equation 1 to convert the input signal (x).

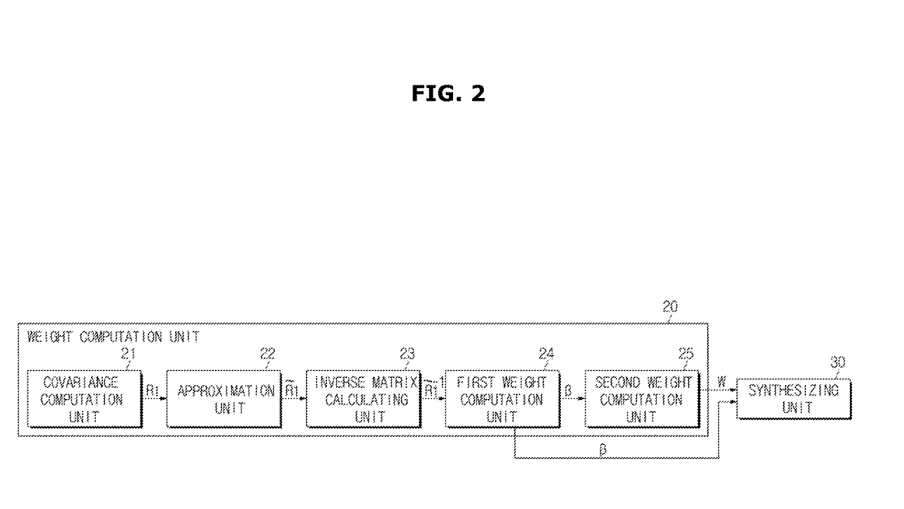

According to an exemplary embodiment, as illustrated in FIG. 2, the weight computation unit 20 may compute the input signal weight (ω) and/or the conversion signal weight (β). FIG. 2 is a block diagram which illustrates the weight computation unit, according to an exemplary embodiment.

More specifically, the weight computation unit 20 may include a covariance computation unit (also referred to herein as a “covariance computation processor”) 21, an approximation unit (also referred to herein as an “approximator” and/or as an “approximation processor”) 22, an inverse matrix calculating unit (also referred to herein as an “inverse matrix calculator”) 23, and a first weight computation unit (also referred to herein as a “first weight computation processor”) 24. Depending on particular embodiments, a second weight computation unit (also referred to herein as a “second weight computation processor”) 25 may be further included.

The covariance computation unit 21 computes a covariance of the conversion signal (u) which is obtained by converting the input signal (x). The covariance may be computed by using the following Equation 4.

R=(XX^{H}) Equation 4

When the conversion signal (u) is input to the weight computation unit 20, the covariance computation unit 21 computes a covariance by using the following Equation 5.

R₁=E[u·u^{H}] Equation 5

In Equation 5, R₁ represents covariance, and u represents a conversion signal.

Alternatively, when the input signal (x) is input to the weight computation unit 20, the covariance computation unit 21 computes a covariance by using the following Equation 6.

R₁=E[V^{H}x·x^{H}V] Equation 6

In Equation 6, R₁ represents covariance, V represents the above-described conversion function, and x represents an input signal. When the above Equation 1 is applied to Equation 6, as shown in the following Equation 7, computing a covariance using the input signal (x) and Equation 6 is the same as computing the covariance of the conversion signal (u) shown in Equation 5.

$$\begin{matrix}{R}_{1} = E [ {V}^{H} x \cdot {x}^{H} V ] \\ = E [ u \cdot {u}^{H} ]\end{matrix} \qquad Equation 7$$

When the covariance computation unit 21 computes a covariance (R₁) of the conversion signal (u), a computation result is delivered to the approximation unit 22. According to an exemplary embodiment, the approximation unit 22 performs a Toeplitz approximation using the computed covariance (R₁). More specifically, the approximation unit 22 generates an approximate matrix of a Toeplitz matrix form based on the covariance (R₁) which is represented as a predetermined matrix form.

The term “Toeplitz matrix” refers to a matrix in which each element on a descending diagonal from left to right is constant. In the Toeplitz matrix, it is simple to compute an inverse matrix, and a corresponding computational complexity is lower than the complexity generally associated with other matrices when an inverse matrix thereof is computed using an information processing device. Therefore, it is possible to improve an inverse matrix computation speed.

The covariance computation unit 21 performs a Toeplitz approximation by using the following Equation 8.

$${\tilde{R}}_{1 , m} = \frac{1}{L - m} {\sum }_{l = 1}^{L - m} {R}_{1 , l , l + m} ( m = 0 , 1 , … , L - 1 ) \qquad Equation 8$$

In Equation 8, R_{1,l,l+m} represents an element in the l-th row and m-th column of the covariance (R₁). L represents the number of rows of a covariance R of the conversion signal.

When \tilde{R}_{1,m} obtained using Equation 8, \tilde{R}_{1,m} is input to an m-th diagonal of an approximate matrix (\tilde{R}₁) in which the covariance (R₁) is approximated. As a result, the approximate matrix \tilde{R}₁ in which the covariance (R₁) is Toeplitz approximated is finally obtained.

The approximate matrix \tilde{R}₁ computed by the approximation unit 22 is delivered to the inverse matrix calculating unit 23. The inverse matrix calculating unit 23 computes an inverse matrix \tilde{R}₁⁻¹ of the approximate matrix \tilde{R}₁.

The inverse matrix \tilde{R}₁⁻¹ computed by the inverse matrix calculating unit 23 is delivered to the first weight computation unit 24. The first weight computation unit 24 computes the conversion signal weight (β) based on the delivered inverse matrix of the approximate matrix. Depending on particular embodiments, the first weight computation unit 24 may compute the conversion signal weight (β) by using the following Equation 9.

$$β = \frac{{\tilde{R}}_{1}^{- 1} {v}_{1}}{{v}_{1}^{H} {\tilde{R}}_{1}^{- 1} {v}_{1}} \qquad Equation 9$$

In Equation 9, β is a computed conversion signal weight, \tilde{R}₁⁻¹ is an inverse matrix of the approximate matrix \tilde{R}₁ computed by the above inverse matrix calculating unit 23, and v₁ is a steering vector.

The steering vector (v₁) is used to control a phase of a signal. According to an exemplary embodiment, the steering vector (v₁) in Equation 9 may be a steering vector that is converted by using a predetermined conversion function. In this case, in order to convert the steering vector, the same conversion function (V) that is used to convert the input signal (x) may be used. Then, more specifically, the converted steering vector v₁ may be computed by using the following Equation 10.

v₁=V^{H}a Equation 10

In Equation 10, a represents a steering vector that is previously defined before conversion, and v₁ represents a converted steering vector.

The conversion signal weight (β) computed by using the above Equation 9 may vary according to the input signal (x) or the conversion function (V) used in the covariance computation unit 21. In this case, because the conversion function (V) is computed and defined in advance, and is selected and used according to the input signal (x), the conversion signal weight (β) mainly varies based on the input signal (x).

The conversion signal weight (P) may be given as a predetermined column vector. When the conversion function (V) is represented as an (M×N) matrix, the conversion signal weight (β) is given as an (N×1) matrix, that is, an (N×1) column vector.

The computed conversion signal weight (β) is delivered to the second weight computation unit 25 and/or to the synthesizing unit 30. When the conversion signal (u) is input to the synthesizing unit 30, the first weight computation unit 24 may deliver the computed conversion signal weight (β) to the synthesizing unit 30. When the input signal (x) is input to the synthesizing unit 30, the first weight computation unit 24 may also deliver the computed conversion signal weight (β) to the second weight computation unit 25.

The second weight computation unit 25 computes the input signal weight (ω) based on the computed conversion signal weight (β). The input signal weight (ω) may be computed by combining the conversion function used for the conversion signal (u) and the conversion signal weight (β) computed by the first weight computation unit 24. To this end, the second weight computation unit 25 calls the conversion function (V) which was used in the covariance computation unit 21, and then combines the conversion signal weight (β) and the called conversion function (V) in order to compute the input signal weight (ω). These operations may be expressed as the following Equation 11.

ω=Vβ Equation 11

The input signal weight (ω) computed in this way may be an optimal weight for input signal (x) beamforming. It is assumed that the input signal weight (ω) is an optimal value for the input signal (x). In this case, in Equation 11, it is finally understood that the conversion signal weight (β) is a weight that is assigned to at least one conversion function (V) in order to compute an optimal value for the input signal weight (ω) with respect to the input signal (x).

The computed input signal weight (ω) is delivered to the synthesizing unit 30.

The synthesizing unit 30 may generate an output signal (z) using the input signal (x) and the input signal weight (ω), and/or by using the conversion signal (u) and the conversion signal weight (β).

When the weight computation unit 20 computes the input signal weight (ω) using the first and second weight computation units 24 and 25, and outputs the result, the synthesizing unit 30 performs a weighted sum of the input signal (x) and the input signal weight (ω) using the following Equation 12, generates an output signal (z), and then outputs the signal to the outside.

Z=ωX Equation 12

When the weight computation unit 20 computes the conversion signal weight (β) using the first weight computation unit 24 and outputs the result, the synthesizing unit 30 may perform a weighted sum of the input conversion signal (u) and the conversion signal weight (β) by using the following Equation 13, generate an output signal (z), and then output the generated output signal (z).

Z=βu Equation 13

The output signals which are outputted according to Equations 12 and 13 are the same. More specifically, an output signal (z) that is a weighted sum of the input signal (x) and the input signal weight (ω) after the input signal weight (ω) for the input signal (x) is computed is the same as an output signal (z) that is a weighted sum of the conversion signal (u) and the conversion signal weight (β) after the conversion signal weight (β) for the conversion signal (u) is computed. This can be demonstrated by the following Equation 14.

$$\begin{matrix}Z = {β}^{H} u \\ = {β}^{H} {V}^{H} x \\ = {( V β )}^{H} x \\ = {w}^{H} x\end{matrix} \qquad Equation 14$$

As described above, the synthesizing unit 30, that has received the input signal (x) and/or the conversion signal (u) into which the input signal (x) is converted using the predetermined conversion function (V) may generate the output signal (z) using the input signal weight (ω) and/or the conversion signal weight (β). As a result, the beamformer 1 may generate and output the output signal (z) in which beamforming is performed on a predetermined input signal (x).

FIG. 3 is a diagram which illustrates a configuration of a beamformer, according to another exemplary embodiment. As illustrated in FIG. 3, a beamformer 1 may include a converting unit (also referred to herein as a “converter”) 10, a weight computation unit 20, and a synthesizing unit 30.

The converting unit 10 converts an input signal (x) into a conversion signal (u) by using a conversion function (V). More specifically, as illustrated in FIG. 3, the converting unit 10 receives an input signal (x) from the outside, converts the received input signal (x) by using a predetermined conversion function (V), and outputs a conversion signal (u) into which the input signal (x) has been converted.

According to an exemplary embodiment, the converting unit 10 may convert the input signal (x) according to the conversion function (V) which is predetermined by a user and/or by a system designer. According to another exemplary embodiment, the converting unit 10 may receive the conversion function (V) for input signal (x) conversion from a conversion function database 50 which includes at least one conversion function (V), and generate a conversion signal (u) by using the conversion function received from the database 50.

As shown in Equation 1, more specifically, the converting unit 10 may apply the conversion function (V) to the input signal (x), and generate the conversion signal (u).

In this case, when the conversion function (V) of Equation 1 is appropriately given, dimensions of the conversion signal u become fewer than dimensions of the input signal (x). For example, when the conversion function is given as an (M×N) and the input signal is given as an (M×1) (that is, the input signal x has M dimensions), when M is greater than N (M>N), the conversion signal u becomes an (N×1) matrix, and the dimensions of the conversion signal (u) becomes fewer than that of the input signal (x). As the number of dimensions decreases, computational complexity correspondingly decreases, so that resource requirements which are necessary for computation decrease and a computation speed increases.

As illustrated in FIG. 3, the conversion signal (u) generated by the converting unit 10 is delivered to the weight computation unit 20.

According to an exemplary embodiment, as illustrated in FIG. 2, the weight computation unit 20 computes an input signal weight (ω) for the input signal (x) via the covariance computation unit 21, the approximation unit 22, the inverse matrix calculating unit 23, and the first and second weight computation units 24 and 25. The computed input signal weight (ω) is delivered to the synthesizing unit 30.

In this case, because the conversion signal (u) is computed and generated in advance by the converting unit 10, the covariance computation unit 21 may compute a covariance of the conversion signal (u) by using the above Equation 5.

The synthesizing unit 30 receives the input signal weight (ω) from the weight computation unit 20, and generates an output signal (z) using the input signal (x) and the input signal weight (ω). More specifically, the synthesizing unit 30 performs a weighted sum of the input signal (x) and the input signal weight (ω) as shown in Equation 12, and generates the output signal (z).

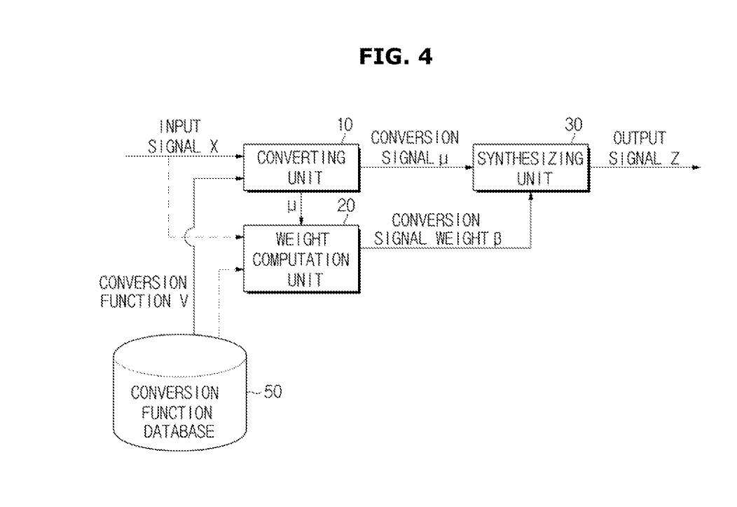

FIG. 4 is a diagram which illustrates a configuration of a beamformer, according to another exemplary embodiment. As illustrated in FIG. 4, a beamformer 1 may include a converting unit 10, a weight computation unit 20, and a synthesizing unit 30.

As described above, the converting unit 10 converts an input signal (x) into a conversion signal (u) by using a predetermined conversion function (V). The converting unit 10 delivers the generated conversion signal to both of the weight computation unit 20 and the synthesizing unit 30. In this case, the converting unit 10 browses a conversion function database 50, calls an appropriate conversion function (V) for the input signal (x), and then converts the input signal (x) using the called conversion function (V) as shown in Equation 1.

As illustrated in FIG. 2, the weight computation unit 20 may compute a conversion signal weight (β) for the conversion signal (u) via the covariance computation unit 21, the approximation unit 22, the inverse matrix calculating unit 23, and the first weight computation unit 24.

As described above, because the conversion signal (u) is generated in advance by the converting unit 10, the covariance computation unit 21 may compute a covariance of the conversion signal (u) using the above Equation 5.

The computed conversion signal weight (β) is delivered to the synthesizing unit 30.

The synthesizing unit 30 receives the conversion signal (u) from the converting unit 10, receives the conversion signal weight (β) from the weight computation unit 20, and then generates an output signal (z) using the conversion signal (u) received from the converting unit 10 and the conversion signal weight (β) received from the weight computation unit 20. In order to generate the output signal (z), the synthesizing unit 30 performs a weighted sum of the conversion signal (u) and the conversion signal weight (β) as shown in Equation 13.

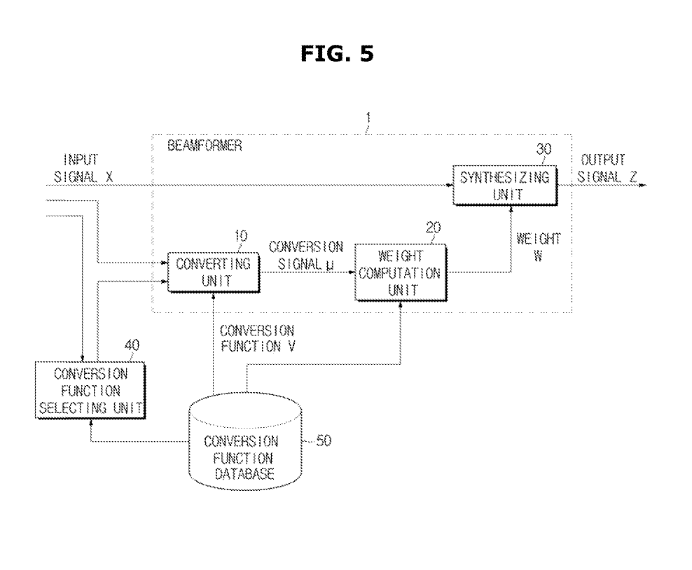

FIG. 5 is a diagram which illustrates a configuration of a beamformer, according to another exemplary embodiment. As illustrated in FIG. 5, according to the embodiment, a beamformer 1 may further include a conversion function selecting unit (also referred to herein as a “conversion function selector”) 40. The conversion function selecting unit 40 selects at least one conversion function (V) from among a plurality of conversion functions (V₁ to Vₙ) which are stored in a conversion function database 50. The selected conversion function (V) is delivered to either one or both of the converting unit 10 and the weight computation unit 20. Depending on particular embodiments, the selected conversion function (V) may be delivered to both of the converting unit 10 and the weight computation unit 20.

The conversion function selecting unit 40 selects at least one conversion function (V) from among a plurality of conversion functions (V₁ to Vₙ) which are stored in the conversion function database 50 based on predetermined settings. In this case, the conversion function selecting unit 40 may select an appropriate conversion function (V) based on the input signal (x). Moreover, the conversion function selecting unit 40 may select the conversion function (V) based on instructions and/or commands which are input by, for example, a user.

More specifically, as illustrated in FIG. 3, the conversion function selecting unit 40 receives the same input signal (x) as the converting unit 10 or the weight computation unit 20, analyzes the input signal (x), and then browses the conversion function database 50 and selects an optimal conversion function (V) which correspond to the received input signal (x) from among at least one conversion function stored in the conversion function database 50.

The conversion function selecting unit 40 delivers information which relates to the conversion function (V) selected by the above method to either or both of the converting unit 10 and the weight computation unit 20, and either or both of the converting unit 10 and the weight computation unit 20 call the conversion function (V) from the conversion function database 50 based on the received information on the conversion function (V). Alternatively, the conversion function selecting unit 40 may call and receive the conversion function (V) from the conversion function database 50, and then deliver the received conversion function (V) to either or both of the converting unit 10 and the weight computation unit 20. As described above, the converting unit 10 computes a conversion signal (u) based on the received conversion function (V), and then delivers the computed signal to the weight computation unit 20. Depending on particular embodiments, the conversion signal (u) may be delivered to the synthesizing unit 30. The weight computation unit 20 computes an input signal weight (ω) and/or a conversion signal weight (β) by using the received conversion function (V), and delivers the result to the synthesizing unit 30.

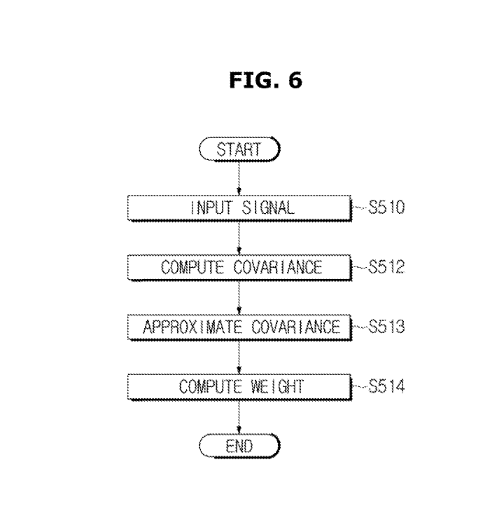

Hereinafter, a beamforming method that can be performed in the above-described beamformer 1 according to an exemplary embodiment will be described. First, a weight computation method which is usable for beamforming according to an exemplary embodiment will be described. FIG. 6 is a flowchart which illustrates the weight computation method, according to the exemplary embodiment.

As illustrated in FIG. 6, in operation S501, a predetermined signal is input first in order to perform beamforming. In this case, an input signal may include a raw data signal (x) and/or a conversion signal (u) that is obtainable by converting the raw data signal (x) using a predetermined conversion function (V).

Subsequently, in operation S512, a covariance of the conversion signal (u) is computed. In this case, when the raw data signal (x) is input, the raw data signal (x) is converted first, the conversion signal (u) is obtained, and then the covariance may be computed by using the obtained conversion signal (u). In this case, the above Equation 5 may be used. Otherwise, the covariance of the conversion signal (u) may be computed by using the raw data signal (x) and the conversion function (V). In this case, the above Equation 6 may be used. The computed covariance may be represented as a matrix form.

Then, in operation S513, an approximation of the computed covariance is determined. For example, the covariance computed using the above Equation 8 may be changed to a Toeplitz matrix form so as to compute an approximate matrix, and the computed covariance is approximated.

In operation S514, a weight for the raw data signal (x) and/or a weight for the conversion signal (u) for the raw data signal (x) is computed using the approximated covariance.

When data to which the weight will be assigned is the raw data signal (x), an inverse matrix of the approximated covariance is computed, the conversion signal weight (β) is computed using Equation 9, and then a weight (ω) for the raw data signal (x) is computed by multiplying the conversion signal weight (β) and the conversion function (V) using Equation 11.

When data to which the weight will be assigned is the conversion signal (u) into which the raw data signal (x) is converted, an inverse matrix of the approximated covariance is computed, and a weight (β) for the conversion signal (u) is computed by computing the conversion signal weight (β) using Equation 9.

As a result, the weight to be used for beamforming, that is, a beamforming coefficient, is computed.

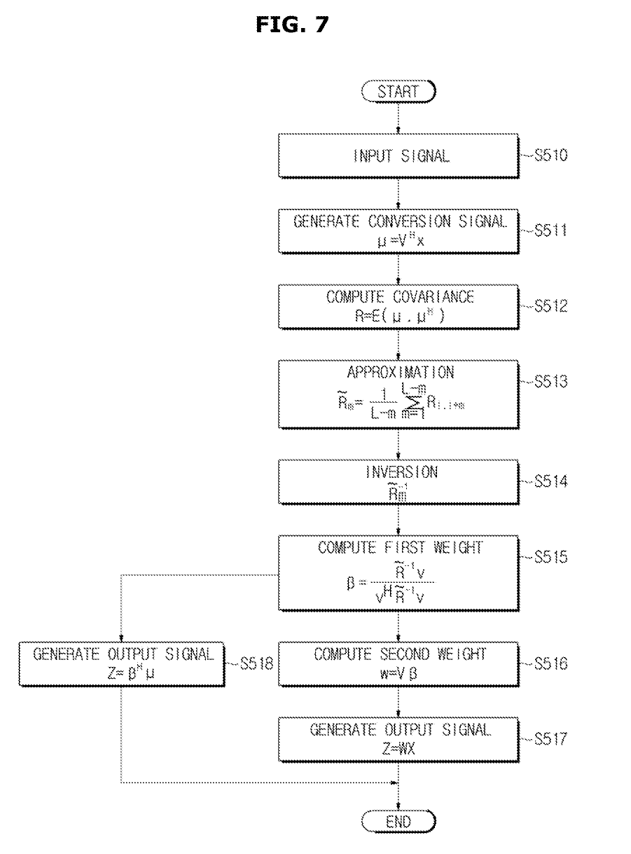

Hereinafter, a beamforming method according to an exemplary embodiment will be described. FIG. 7 is a flowchart which illustrates the beamforming method, according to the exemplary embodiment. As illustrated in FIG. 7, first, in operation S510, a raw data signal (x) is input from an external signal receiver, such as, for example, a transducer of an ultrasound probe.

Depending on particular embodiments, in operation S511, the raw data signal (x) is converted by using a predetermined conversion function (V) in order to generate a conversion signal (u). As described above, it is not always necessary that the conversion signal (u) will be generated.

In operation S512, a covariance (R₁) of the conversion signal (u) is computed. In this case, when the conversion signal (u) is previously obtained in previous operation S511, the covariance (R₁) is computed and obtained using Equation 5. Conversely, when the conversion signal (u) is not obtained, the covariance (R₁) of the conversion signal (u) is computed and obtained by using the predetermined conversion function (V) and the raw data signal (x) by applying Equation 6.

After the covariance (R₁) of the conversion signal (u) is obtained, in operation S513, an approximate matrix is generated based on the covariance (R₁) of the conversion signal (u). In this case, the covariance (R₁) represented as a matrix form may be changed to a Toeplitz matrix form. In order to change the covariance (R₁) to the Toeplitz matrix form, the above Equation 8 may be used.

When the approximate matrix is obtained, in operation S514, an inverse matrix of the approximate matrix is computed.

Then, in operation S515, the computed inverse matrix of the approximate matrix is applied to the above Equation 9, and a first weight, that is, a conversion signal weight (β), is computed.

In the beamforming method according to the exemplary embodiment, after the conversion signal weight (β) is computed, in operation S516, a second weight, that is, an input signal weight (ω), is computed by combining the conversion signal weight (β) and the conversion function (V). In this case, Equation 11 may be used.

As shown in Equation 12, in operation S517, a weighted sum of the input signal weight (ω) and the raw data signal (x) is performed in order to generate an output signal (z), that is, a beamformed signal. As a result, beamforming for the raw data signal ends.

Alternatively, in a beamforming method according to another exemplary embodiment, in operation S518, after the conversion signal weight (β) is computed, a weighted sum of the conversion signal weight (β) and the conversion signal (u) is performed in order to generate the output signal (z). According to this method, the number of operations becomes fewer as illustrated in FIG. 7. However, in this case, the conversion signal generating operation (i.e., operation S511) must be performed in advance.

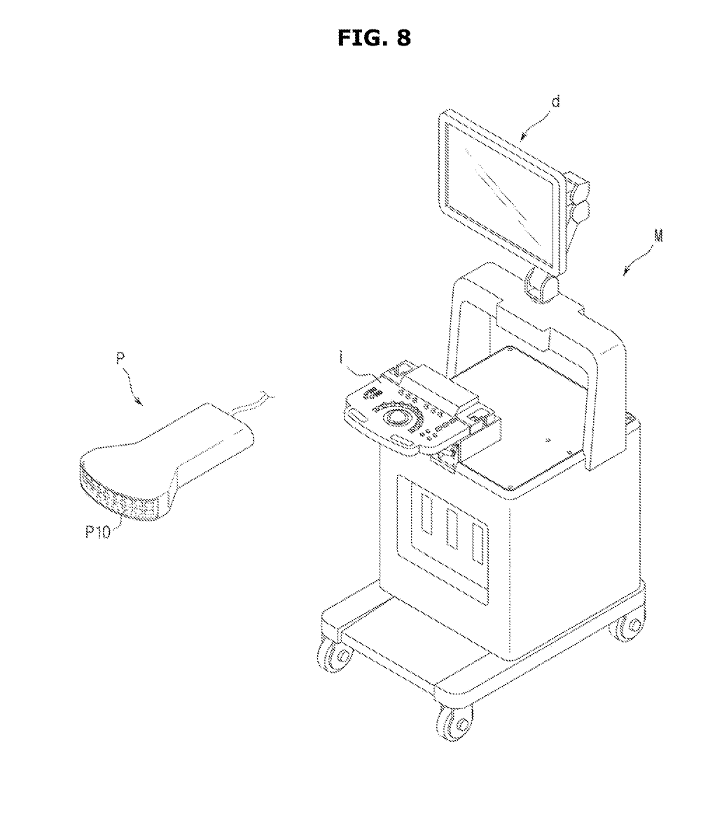

Hereinafter, an ultrasonic imaging apparatus to which the above-described beamformer 1 is applicable according to an exemplary embodiment will be described with reference to FIGS. 8 to 14. In addition, a control method which is executable by such an ultrasonic imaging apparatus will be described.

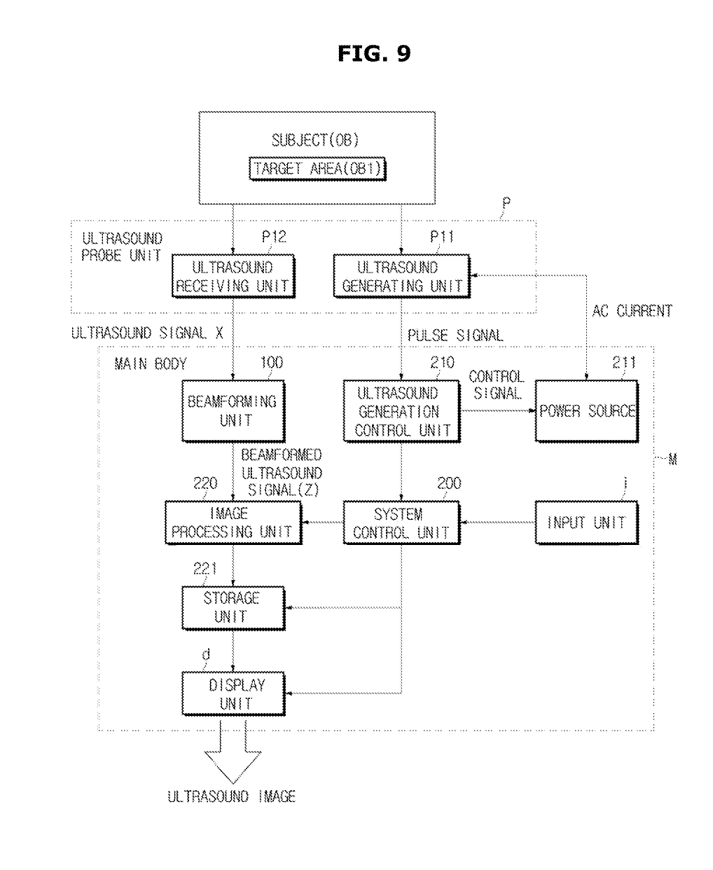

FIG. 8 is a perspective view which illustrates an ultrasonic imaging apparatus, according to an exemplary embodiment. FIG. 9 is a diagram which illustrates a configuration of the ultrasonic imaging apparatus, according to the exemplary embodiment.

As illustrated in FIGS. 8 and 9, the ultrasonic imaging apparatus may include an ultrasound probe unit (P) (also referred to herein as an “ultrasound probe device”) configured to receive an ultrasonic wave from a subject (ob) and to convert the received ultrasonic wave into an electrical signal, that is, an ultrasound signal, and a main body (M) configured to generate an ultrasound image based on the ultrasound signal.

More specifically, as illustrated in FIG. 9, the ultrasound probe unit (P) of the ultrasonic imaging apparatus may include an ultrasound generating unit (also referred to herein as an “ultrasound generator”) P11 and an ultrasound receiving unit (also referred to herein as an “ultrasound receiver”) P12, and the main body (M) includes, for example, a beamforming unit 100 and system control unit (also referred to herein as a “system controller”) 200, but the exemplary embodiments are not limited thereto. Various components for generating an ultrasound image based on the ultrasound signal, for example, the beamforming unit 100 or an image processing unit (also referred to herein as an “image processor”) 220 in FIG. 9, may be included in the ultrasound probe. Moreover, an input unit (i) or a display unit (d) may be provided in a separate workstation connected to the main body (M), and transmit and receive instructions or commands, and image data with the main body (M) via a wired or wireless communication network. For convenience of description, hereinafter, an exemplary embodiment of the ultrasonic imaging apparatus in which an ultrasound probe serves as the ultrasound probe unit (P) and the main body (M) performs beamforming or image processing will be described.

The ultrasound probe unit (P) collects information on a target area (ob1) of the subject (ob) using the ultrasonic wave, and may be the ultrasound probe as illustrated in FIG. 8.

As illustrated in FIG. 9, the ultrasound probe unit (P) may include an ultrasound generating unit P11 configured to generate an ultrasonic wave and emit the ultrasonic wave to the target area (ob1) inside the subject (ob), and an ultrasound receiving unit P12 configured to receive an echo ultrasonic wave.

The ultrasound generating unit P11 generates an ultrasonic wave based on a pulse signal and/or an AC current which is applied to the ultrasound generating unit P11 under control of an ultrasound generation control unit (also referred to herein as an “ultrasound generation controller”) 210 provided in, for example, the main body (M). The ultrasonic wave generated from the ultrasound generating unit P11 is reflected at the target area (ob1) inside the subject (ob). The ultrasound receiving unit P12 receives the reflected ultrasonic wave, that is, an echo ultrasonic wave, converts the echo ultrasonic wave received by vibrating at a frequency of the echo ultrasonic wave into a predetermined electrical signal (hereinafter referred to as an “ultrasound signal”), and outputs the result. As a result, the ultrasound receiving unit P12 may output an ultrasound signal (x). According to an exemplary embodiment, in a hybrid imaging apparatus in which the ultrasonic imaging apparatus is combined with a photoacoustic imaging apparatus, the ultrasound receiving unit P12 may receive a sound wave, for example, the ultrasonic wave, which is generated from the target area (ob1) due to, for example, laser emission.

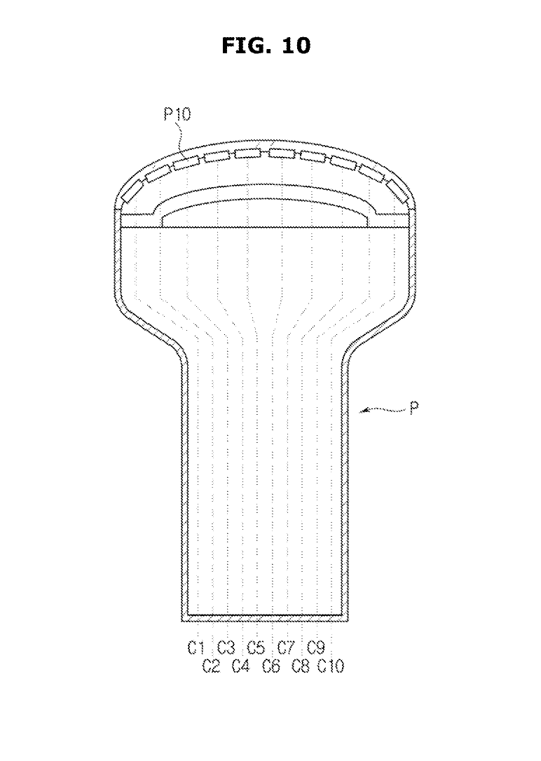

These functions of the ultrasound generating unit P11 and the ultrasound receiving unit P12 may be performed by an ultrasound transducer P10 that is provided at the end of the ultrasound probe unit (P). FIG. 10 is a plan view which illustrates the ultrasound probe unit, according to an exemplary embodiment. As illustrated in FIG. 10, the ultrasound transducer P10 is provided at one end of the ultrasound probe unit (P).

A transducer is an element that converts a certain form of energy into another form of energy, for example, electric energy into wave energy or light energy. The ultrasound transducer P10 mutually converts wave energy and electric energy. More specifically, the ultrasound transducer P10 generates an ultrasonic wave by vibrating according to a predetermined input pulse current, and generates an electrical signal having a predetermined pulse by vibrating according to the ultrasonic wave received from the outside, for example, the echo ultrasonic wave. Therefore, the ultrasound transducer P10 may perform all functions of the ultrasound generating unit P11 and the ultrasound receiving unit P12 as described above.

More specifically, the ultrasound transducer P10 is supplied with an AC current from an external power supplying device or an internal condenser, such as, for example, a power source 211 such as a battery, and generates an ultrasonic wave by vibrating, for example, a piezoelectric vibrator or a thin film of the ultrasound transducer P10, based on the applied power source. Conversely, when a piezoelectric substance or the thin film is vibrated according to ultrasonic wave reception, the ultrasound transducer P10 generates an AC current which has a frequency that corresponds to a vibration frequency of the piezoelectric substance or the thin film, and converts the ultrasonic wave into the electrical signal, that is, the ultrasound signal (x).

As illustrated in FIG. 10, a plurality of ultrasound transducers P10 may be provided at the end of the ultrasound probe unit (P). For example, 64 or 128 ultrasound transducers P10 may be provided at the end of the ultrasound probe unit (P). In this way, when the plurality of ultrasound transducers P10 are provided at one end of the ultrasound probe unit (P), the ultrasound signal to be delivered is also delivered to the beamforming unit 100 via a plurality of channels which respectively correspond to the number of ultrasound transducers P10, for example, 64 or 128 channels (C1 to C10).

Examples of the ultrasonic wave transducer P10 may include a magnetostrictive ultrasonic transducer which uses a magnetostrictive effect of a magnetic substance, a piezoelectric ultrasonic transducer which uses a piezoelectric effect of a piezoelectric material, and a capacitive micromachined ultrasonic transducer (cMUT) that transmits and receives an ultrasonic wave by using vibrations of several hundreds or thousands of micromachined thin films. Moreover, any one or more of various types of transducers which are capable of generating an ultrasonic wave based on an electrical signal and/or generating an electrical signal based on an ultrasonic wave may also be used as the above-described ultrasonic wave transducer.

As illustrated in FIG. 9, the main body (M) may include the beamforming unit 100, the system control unit 200, the ultrasound generation control unit 210, the image processing unit 220, a storage unit (also referred to herein as a “storage device” and/or as a “storage”) 221, the input unit (i), and the display unit (d).

The beamforming unit 100 receives the ultrasound signal of a plurality of channels from the ultrasound probe unit (P) and performs beamforming of the ultrasound signal (x).

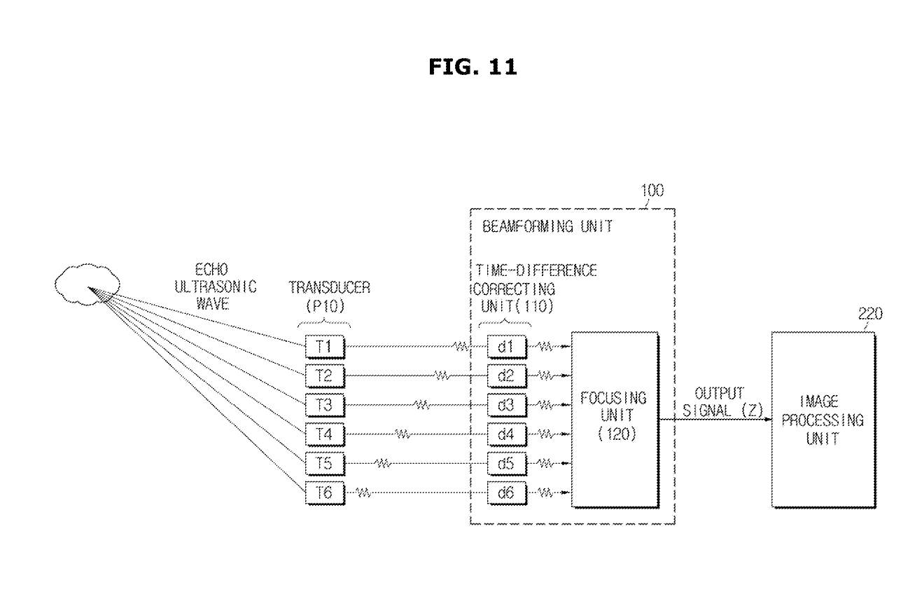

FIG. 11 is a diagram which illustrates the beamforming unit 100, according to an exemplary embodiment. As illustrated in FIG. 11, the beamforming unit 100 may include a time-difference correcting unit (also referred to herein as a “time-difference corrector”) 110 and a focusing unit (also referred to herein as a “focuser”) 120.

As illustrated in FIG. 11, the ultrasonic wave reflected at or generated from the target area (ob1) of the subject (ob) is received by the ultrasound receiving unit P11, for example, the ultrasound transducer P10, as described above.

Because a distance between each respective pair of the ultrasound transducers (T1, T2, T3, T4, T5, and T6) provided in the ultrasound probe unit (P) and the target area (ob1) is different, and a sound speed is almost constant, although the ultrasonic wave is reflected at or generated from the same target area (ob1), each of the ultrasound transducers (T1 to T6) receives the ultrasonic wave from the same target area (ob1) at a different time. In this aspect, there is a predetermined time difference between ultrasound signals which are respectively output from each of the ultrasound transducers (T1 to T6) based on the ultrasonic wave which is received from the same target area (ob1). Therefore, even when each ultrasound transducer (T1 to T6) receives an ultrasonic wave at a different time, the ultrasonic wave may be delivered from the same target area (ob1). Accordingly, it is necessary to correct the time difference between ultrasound signals generated by each ultrasound transducer (T1 to T6) prior to performing additional signal processing functions.

The time-difference correcting unit 110 of the beamforming unit 100 corrects such a time difference between ultrasound signals. As illustrated in FIG. 11, for example, the time-difference correcting unit 110 may delay a transmission of the ultrasound signal which is input via a specific channel by a predetermined time, and thereby cause the ultrasound signal (x) which is input via each channel to reach the focusing unit 120 at the same time.

The focusing unit 120 may focus the time-difference corrected ultrasound signal (x).

More specifically, the focusing unit 120 may focus the ultrasound signal such that a predetermined weight, that is, a beamforming coefficient, is assigned to each input ultrasound signal, in order to emphasize a signal of a specific area or relatively attenuate a signal of a different area. Therefore, it is possible to generate an ultrasound image based on user requirements or convenience.

In this case, the focusing unit 120 may focus the ultrasound signal by using a beamforming coefficient which is determined independently from the ultrasound signal which is output from the ultrasound receiving unit P12 (i.e., the data-independent beamforming method). Alternatively, an optimal beamforming coefficient is computed based on an input ultrasound signal, and then the ultrasound signal may be focused by using the computed beamforming coefficient (i.e., the adaptive beamforming method).

A beamforming process which is performed in the ultrasonic imaging apparatus may be generally represented as the following Equation 15.

$$z [ n ] = {\sum }_{m = 0}^{M - 1} {w}_{m} [ n ] {x}_{m} [ n - {Δ}_{m} [ n ] ] \qquad Equation 15$$

In Equation 15, n is a value which represents a position of the target area (ob1), m is an identification number of a channel of the ultrasound signal which is collected by the transducer (P10), and wₘ[n] is a beamforming coefficient (w) which is assigned to an ultrasound signal of an m-th channel that is reflected at a position of n and is collected by an m-th transducer (P10). Further, Δₘ is a time delay value that is used to delay a transmission time of the ultrasound signal which is input via a specific channel by a certain amount of time. As described above, the time delay is performed by the time-difference correcting unit 110. Therefore, xₘ[n−Δₘ[n]] refers to an ultrasound signal of each channel in which the time difference is corrected.

When it is assumed that the time difference of the input signal has already been corrected, the above Equation 15 may be rewritten as the following Equation 16.

z=w^{H}x Equation 16

In particular, in general ultrasonic wave beamforming, as expressed in Equations 15 and 16, after a time difference of the ultrasound signal (x) of each channel is corrected, a predetermined weight is assigned to the time-difference corrected signal (x−Δx), and the focused ultrasound signal (x′) is output (delay and sum).

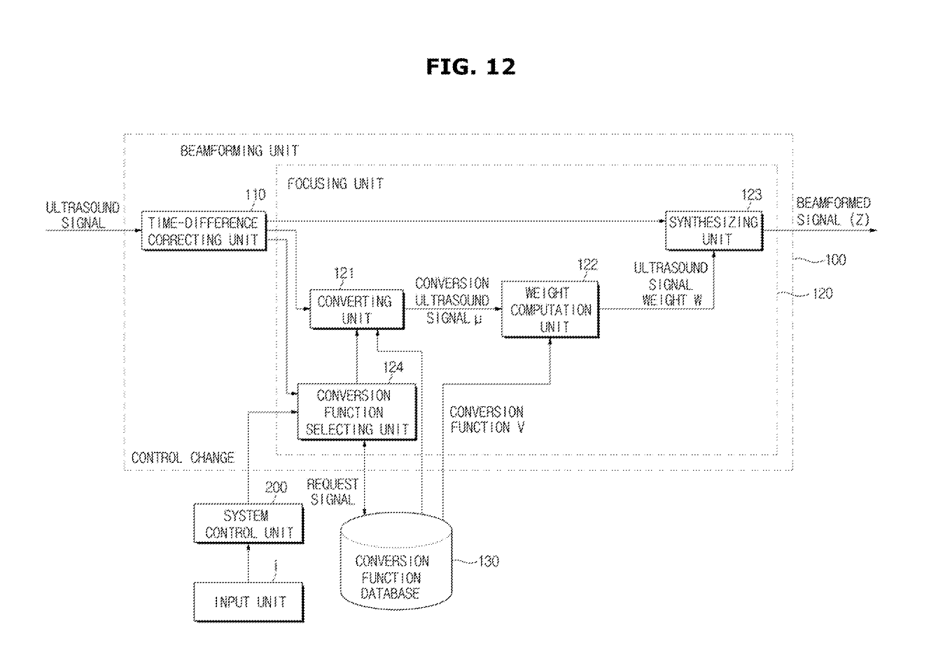

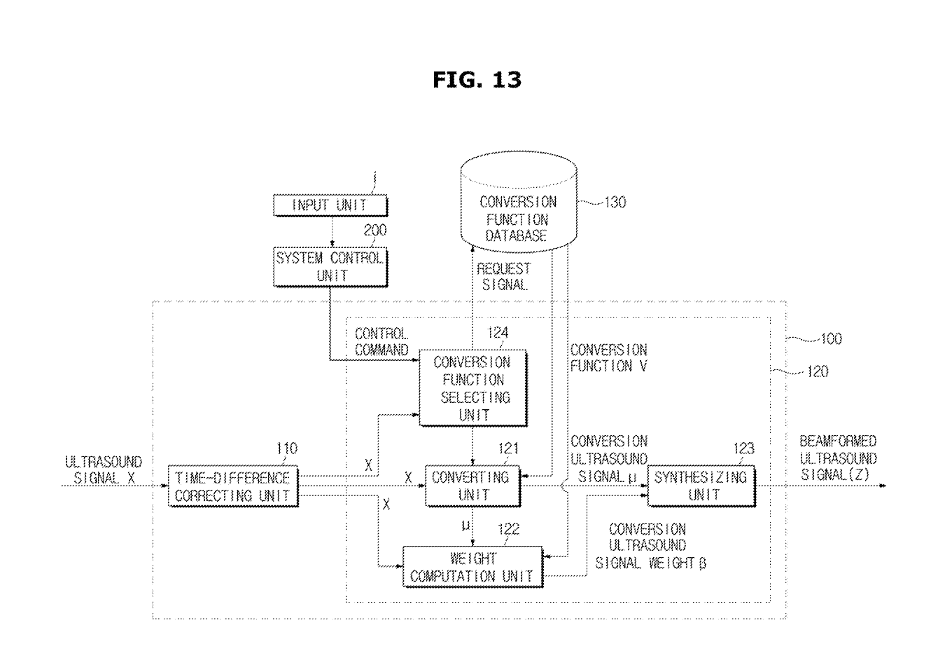

Hereinafter, with reference to FIGS. 12 and 13, the focusing unit 120 of the beamforming unit 100 according to an exemplary embodiment will be described. FIG. 12 is a diagram which illustrates the beamforming unit, according to the exemplary embodiment. As illustrated in FIG. 12, the focusing unit 120 may include a converting unit (also referred to herein as a “converter”) 121, a weight computation unit (also referred to herein as a “weight computation processor”) 122, a synthesizing unit (also referred to herein as a “synthesizer”) 123, and a conversion function selecting unit (also referred to herein as a “conversion function selector”) 124.

The converting unit 121 receives ultrasound signals (x) of a plurality of channels in which the time difference is corrected by the time-difference correcting unit 110, and converts the plurality of input ultrasound signals (x) in order to generate a conversion ultrasound signal (u). The generated conversion ultrasound signal (u) is delivered to the weight computation unit 122. Depending on particular embodiments, the generated conversion ultrasound signal (u) may be delivered to the synthesizing unit 123.

The converting unit 121 generates the conversion ultrasound signal (u) by using a predetermined conversion function (V). In this case, the converting unit 121 may compute the conversion ultrasound signal (u) by using the above Equation 1.

Further, the predetermined conversion function (V) which is used by the converting unit 121 may be stored in a separate conversion function database 130. The conversion function database 130 is a database which includes at least one predetermined conversion function (V₁ to Vₙ). The at least one conversion function (V) which is stored in the conversion function database 130 may be pre-computed and obtained based on any one or more of various forms of ultrasound signals (x) that can be obtained empirically or theoretically. Moreover, the conversion functions (V) included in the conversion function database 130 may include a basis vector that is obtained based on a separately computed beamforming coefficient (w) in advance and/or based on a combination of a plurality of basis vectors. The pre-computed beamforming coefficient (w) is computed by using the ultrasound signal (x) that is input or can be input. In this case, the beamforming coefficient (w) may be an optimal beamforming coefficient (w*) that is obtainable by applying a minimum variance method to the ultrasound signal of the plurality of channels. The basis vectors which are obtained based on the beamforming coefficient (w) may be obtained by performing a principal component analysis for the beamforming coefficient (w or w*). In addition, the plurality of basis vectors which configure the conversion function (V) may include orthogonal vectors that are orthogonal to each other, and more specifically, may include eigenvectors and/or Fourier basis vectors.

Although the converting unit 121 may directly call the predetermined conversion function (V) from the conversion function database 130, the conversion function (V) may be selected and called with the help of the conversion function selecting unit 124.

As illustrated in FIG. 12, the weight computation unit 122 receives the conversion ultrasound signal (u) from the converting unit 121, and computes a weight to be used by the synthesizing unit 123 based on the received conversion ultrasound signal (u). More specifically, the weight computation unit 122 computes an ultrasound signal weight (ω) for the time-difference corrected ultrasound signal of a plurality of channels which is delivered from the time-difference correcting unit 110, or a conversion ultrasound signal weight (β) for the conversion ultrasound signal (u) which is output from the converting unit 121.

The weight computation unit 122 computes a covariance of the conversion signal (u) which is obtained by converting the ultrasound signal (x) by the converting unit 121. In this case, the above Equation 5 may be used. When there is no converting unit 121, as shown in the above Equation 6, the weight computation unit 122 uses the time-difference corrected ultrasound signal (x) and the predetermined conversion function (V) which is read from the conversion function database 130 to compute a covariance (R₁) of the signal which is converted using the predetermined conversion function (V).

Then, the weight computation unit 122 generates a Toeplitz matrix based on the computed covariance (R₁). More specifically, the weight computation unit 122 generates an approximate matrix which has a Toeplitz matrix form based on the covariance (R₁) that is represented as a predetermined matrix form by applying the above Equation 8. As described above, because it is simple to compute an inverse matrix of the Toeplitz matrix, an inverse matrix computation process can be rapidly performed with a relatively small consumption of resources.

After the inverse matrix of the approximate matrix is computed, the weight computation unit 122 computes a conversion ultrasound signal weight (β) by using the computed inverse matrix. In this case, the above Equation 9 may be used.

The weight computation unit 122 computes the ultrasound signal weight (ω) based on the conversion ultrasound signal weight (β). In this case, the ultrasound signal weight (ω) may be computed by using the above Equation 11. In particular, it is possible to compute and obtain the ultrasound signal weight (ω) by performing a weighted sum of the conversion ultrasound signal weight (β) and the conversion function (V).

In this aspect, the conversion function (V) to be used may be read from the conversion function database 130. In this case, the read conversion function (V) may be the same conversion function (V) which is used for computing the conversion ultrasound signal (u) by the converting unit 121, or may be a different conversion function (V) as necessary.

The computed ultrasound signal weight (ω) is delivered to the synthesizing unit 123.

The synthesizing unit 123 generates a beamformed ultrasound signal (z) by using the ultrasound signal (x) and the ultrasound signal weight (ω). The synthesizing unit 123 may generate the beamformed ultrasound signal (z) by performing a weighted sum of the ultrasound signal (x) and the ultrasound signal weight (ω). In this case, the above Equation 12 may be used.

Based on settings which are defined in advance by a user or a system administrator, or based on a user selection which is input via a separate input unit (i), the conversion function selecting unit 124 may select the conversion function (V), which is used in either or both of the converting unit 121 and the weight computation unit 122, from the conversion function database 130. In this case, the system control unit 200 illustrated in FIG. 9 may generate an appropriate control command, and deliver the generated control command to the conversion function selecting unit 124, so that the conversion function selecting unit 124 may select the predetermined conversion function (V).

The focusing unit 120 may generate and output the beamformed ultrasound signal (z) based on the time-difference corrected ultrasound signal (x) by using, for example, the converting unit 121, the weight computation unit 122, and the synthesizing unit 123. As illustrated in FIG. 9, the beamformed ultrasound signal (z) which is output from the beamforming unit 100 is delivered to the image processing unit 220.

FIG. 13 is a diagram which illustrates a beamforming unit 100, according to another exemplary embodiment. As illustrated in FIG. 13, a focusing unit 120 may include a converting unit 121, a weight computation unit 122, a synthesizing unit 123, and a conversion function selecting unit 124.

As illustrated in FIG. 13, the converting unit 121 converts a time-difference corrected ultrasound signal (x) which is delivered from a time-difference correcting unit 110 by using a predetermined conversion function (V) as described in FIG. 12. In this case, the converting unit 121 delivers a conversion ultrasound signal (u) to the weight computation unit 122 and the synthesizing unit 123.

The weight computation unit 122 computes a covariance of the conversion signal and generates a Toeplitz matrix that approximates the computed covariance, and then computes a conversion ultrasound signal weight (β), that is, a weight for the conversion signal (u), by using the generated Toeplitz matrix. In this aspect, the weight computation unit 122 delivers the conversion ultrasound signal weight (β) to the synthesizing unit 123. Unlike the exemplary embodiment described with reference to FIG. 12, the weight computation unit 122 does not compute an ultrasound signal weight (ω) by using the conversion ultrasound signal weight (β).

The synthesizing unit 123 generates a beamformed ultrasound signal (z) by using the conversion ultrasound signal weight (β) and the conversion ultrasound signal (u) which is delivered from the converting unit 121. More specifically, the synthesizing unit 123 may generate the beamformed ultrasound signal (z) by performing a weighted sum of the conversion ultrasound signal (u) and the conversion ultrasound signal weight (β) by using the above Equation 13. In this case, as shown in Equation 14, the synthesizing unit 123 outputs the beamformed ultrasound signal (z) that is the same as in the exemplary embodiment which is illustrated in FIG. 12.

As illustrated in FIGS. 12 and 13, when the beamforming unit 100 focuses the ultrasound signal (x) and outputs the beamformed ultrasound signal, the output beamformed ultrasound signal is delivered to the image processing unit 220 as illustrated in FIG. 9.

The image processing unit 220 of the ultrasonic imaging apparatus generates an ultrasound image based on the beamformed ultrasound signal (z) as a form that visualizes a subject, such as, for example, a human internal body, in order to be visually checked by a user, such as a doctor or a patient.

Depending on particular embodiments, the image processing unit 220 may use a predetermined point spread function (PSF) and restore an ultrasound image that is the same as or similar to an original image based on the beamformed ultrasound signal (z).

Moreover, the image processing unit 220 may further perform separate and additional image processing on the restored ultrasound image. For example, the image processing unit 220 may further perform image post-processing, such as correcting contrast, brightness, and/or sharpness of the ultrasound image, and/or readjusting thereof. In this case, the image processing unit 220 may perform image processing in order to emphasize or attenuate only a part of the generated ultrasound image. In addition, when a plurality of ultrasound images are generated, the image processing unit 220 may generate a stereoscopic ultrasound image by using the plurality of ultrasound images. In this way, additional image processing of the image processing unit 220 may be performed based on predetermined settings, or based on user instructions and/or commands which are input via the input unit (i).

The ultrasound image which is restored and/or on which additional image processing is performed by the image processing unit 220 is delivered to a storage unit 221 and/or to the display unit (d).

The storage unit 221 temporary or permanently stores the ultrasound image generated by the image processing unit 220, and/or the ultrasound image on which additional post-processing is performed.

The display unit (d) displays the ultrasound image that is generated by the image processing unit 220 and/or stored in the storage unit 221 to the user based on the user's request or system settings. Therefore, the user can visually check structures and/or organizations inside the subject (ob). In this case, the display unit (d) may display the generated ultrasound image in real time to the user.

The main body (M) of the ultrasonic imaging apparatus may include the ultrasound generation control unit 210. According to an exemplary embodiment, the ultrasound generation control unit 210 generates a pulse signal by a command of, for example, the system control unit 200, delivers the signal to the ultrasound generating unit P11, and enables the ultrasound generating unit P11 to generate an ultrasonic wave based on the pulse signal. The generated ultrasonic wave is emitted to the subject (ob). According to another exemplary embodiment, the ultrasound generation control unit 210 may generate a separate control signal for the power source 211 based on a control command of, for example, the system control unit 200. The power source 211 applies a predetermined AC current to the ultrasound generating unit P11 under control of the ultrasound generation control unit 210 and causes a piezoelectric element or a thin film of the ultrasound generating unit P11 to vibrate so that the ultrasound generating unit P11 generates an ultrasonic wave.

The main body (M) of the ultrasonic imaging apparatus may include the system control unit 200. The system control unit 200 controls overall operations of, for example, the above ultrasound probe unit (P), the beamforming unit 100, the ultrasound generation control unit 210, the image processing unit 220, the storage unit 221, and the display unit (d), of the ultrasonic imaging apparatus.

Depending on particular embodiments, the system control unit 200 may control operations of the ultrasonic imaging apparatus based on predetermined system settings, and/or generate predetermined control commands based on user instructions and/or commands which are input via a separate input unit (i) and then control operations of the ultrasonic imaging apparatus.

The input unit (i) receives predetermined instructions and/or commands for controlling the ultrasonic imaging device from the user. The input unit (i) may include any one or more of various user interfaces, for example, a keyboard, a mouse, a trackball, and/or a touchscreen.

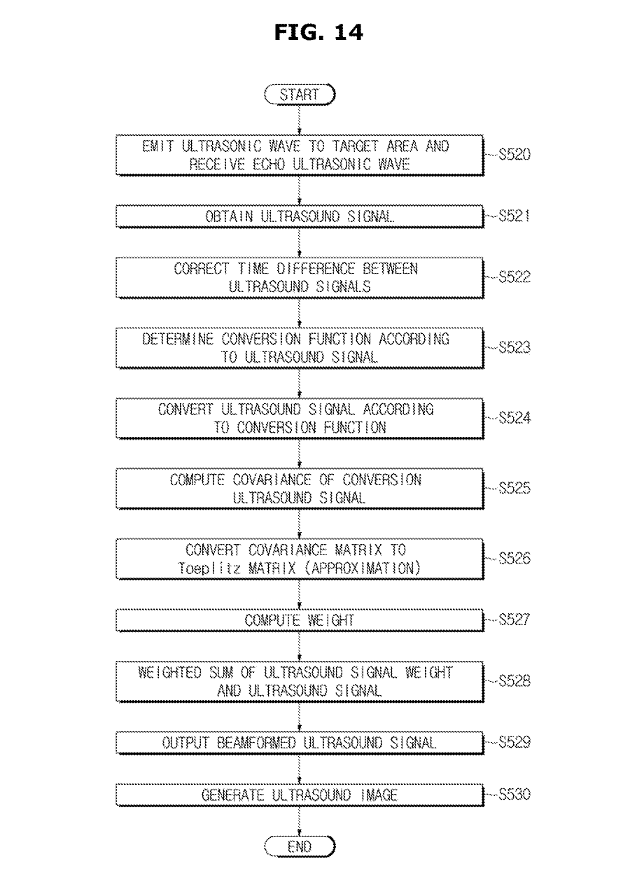

Hereinafter, a control method which is executable by the above-described ultrasonic imaging apparatus will be described with reference to FIG. 14. FIG. 14 is a flowchart which illustrates the control method of the ultrasonic imaging apparatus.

As illustrated in FIG. 14, first, in operation S520, when ultrasonic wave emission is focused on a target area inside a subject (ob) and the ultrasonic wave is emitted to the target area, the emitted ultrasonic wave is reflected at the target area. The reflected ultrasonic wave, that is, an echo ultrasonic wave, is received by an ultrasound probe.

The ultrasound probe is configured to obtain an ultrasound signal (x) by converting the echo ultrasonic wave into an electrical signal. More specifically, in operation S521, the above-described ultrasound transducer P10 converts the echo ultrasonic wave into the electrical signal.

As described above, in operation S522, because there is a time difference between ultrasound signals (x) respectively received by each ultrasound transducer P10, the time difference of the ultrasound signal is corrected prior to executing other signal processing functions. In this case, a method in which an input ultrasound signal is delayed first for a predetermined time and then is output may be used.

According to a time-delayed ultrasound signal (x), in operation S523, an appropriate conversion function (V) for the ultrasound signal (x) is determined. Then, based on the determined conversion function (V), in operation S524, the ultrasound signal (x) is converted and a conversion ultrasound signal (u) is generated.

A covariance (R) of the conversion ultrasound signal (u) is computed in operation S525. In this case, the above Equation 5 may be used. Then, in operation S526, an approximation of the computed covariance (R) is determined and formatted to a Toeplitz matrix form. In this case, as described with reference to Equation 8, an approximate matrix of the Toeplitz matrix form may be computed.

In operation S527, a weight for the ultrasound signal is computed by using the approximate matrix. More specifically, first, an inverse matrix of the approximate matrix of the Toeplitz matrix form is computed, and then a conversion ultrasound signal weight (β) is computed by using Equation 9. Then, as shown in Equation 11, a conversion function (V) is assigned to the conversion ultrasound signal weight (β) and an ultrasound signal weight (ω) is computed.

In operation S528, a weighted sum of the computed ultrasound signal weight (ω) and the ultrasound signal (x) is performed, and in operation S529, a beamformed ultrasound signal (z) is generated and is output. Then, in operation S530, an ultrasound image is generated by using the output beamformed ultrasound signal (z).

According to the above-described method, it is possible to significantly reduce computational complexity which is associated with beamforming. When a conventional beamforming method has a complexity of O(M), a beamforming method which uses a minimum variance method has a corresponding complexity of O(M³). Computational complexity of the beamforming method which is based on using the minimum variance method is the same as or directly proportional to O(M³). In this aspect, in beamforming which is based on using the minimum variance method, it is assumed that the number of channels of the input ultrasound signal is, for example, 128. Then, required computational complexity is expressible as indicated in the following Equation 17.

O(M³)=O(128³)=O(2,097,152) Equation 17

Conversely, when the above-described beamforming method is used, the beamforming method has a corresponding complexity of O(M²). Therefore, computational complexity is expressible as indicated in the following Equation 18.

O(M²)=O(128³)=O(16,384) Equation 18

As a result, it is understood that the computational complexity is significantly reduced. When the above-described conversion function (V) is a conversion function that reduces the number of dimensions of the ultrasound signal, the computational complexity is further reduced. For example, when 10 dimensions are reduced by the conversion function (V), the computational complexity is expressible as indicated in the following Equation 19.

O(M³)=O(10³)=O(1,000) Equation 19

When the above-described conversion function (V) is a conversion function that reduces the number of dimensions of the ultrasound signal, the above-described beamforming unit 100 is used, and 10 dimensions are changed due to the conversion function, the computational complexity is expressible as indicated in the following Equation 20.

O(M²)=O(10²)=O(100) Equation 20

As a result, compared to an adaptive beamforming method which uses only the minimum variance method, the computational complexity is further reduced. Therefore, it is possible to implement the adaptive beamforming method with a high speed and high performance. Accordingly, it is possible to display the ultrasound image in real time to the user.

While the ultrasonic imaging apparatus has been described as an exemplary embodiment in which the beamformer or the beamforming method is applied, applications of the beamformer or the beamforming method are not limited to the ultrasonic imaging apparatus, but include any one or more of various apparatuses that require beamforming, for example, a radar, a sonar, and/or an array microphone, an array speaker, and/or an array antenna in the field of acoustic signal processing.

According to the above-described beamformer and beamforming method, it is possible to reduce a computational complexity which might otherwise be required for beamforming without quality degradation of the beamforming result in beamforming operations in which beamforming output signals are obtained from the input signal. Therefore, various devices that perform beamforming, for example, the ultrasonic imaging apparatus, can save resources necessary for beamforming, and can address various problems, such as, for example, an overload of the device that performs beamforming.

Moreover, due to a decrease in resource usage of the beamforming device, it is possible to decrease power consumption of the beamforming device. Due to low-end computing devices, it is possible to reduce costs.

In addition, it is possible for the beamforming device to perform beamforming processing rapidly due to an increase in a beamforming speed and a decrease in a beamforming time for the input signal.

Therefore, in any one or more of various imaging apparatuses which use the beamformer, for example, in the ultrasonic imaging apparatus, it is possible to implement the ultrasound image in real time and to display the result to the user.

What is claimed is:

1. A beamformer comprising:
a weight computation processor configured to compute a covariance of a conversion signal which is obtainable by converting an input signal using at least one conversion function, to approximate the computed covariance to a Toeplitz matrix form, and to compute an input signal weight which includes at least one from among a direct weight for the input signal and a conversion signal weight that is a weight for the conversion signal based on a result of the approximating; and
a synthesizer configured to generate an output signal using the computed input signal weight.

2. The beamformer according to claim 1, wherein the weight computation processor is further configured to compute an approximate matrix by using a result of the approximating, inverting the computed approximate matrix, and computing the conversion signal weight by using a result of the inverting.

3. The beamformer according to claim 1, wherein the weight computation is further configured to compute an approximate matrix by approximating the computed covariance of the conversion signal to the Toeplitz matrix form by using an equation which is expressible as
$${\tilde{R}}_{1 , m} = \frac{1}{L - m} {\sum }_{l = 1}^{L - m} {R}_{1 , l , l + m}$$
wherein m=0, 1, . . . , L−1, R_{1,l,l+m} represents an element in an l-th row and m-th column of a covariance R of the conversion signal, \tilde{R}_{1,m} is a value of an m-th diagonal of the approximate matrix, and L is a number of rows of the covariance R of the conversion signal.

4. The beamformer according to claim 2, wherein the weight computation processor is further configured to compute the conversion signal weight for the conversion signal by using an equation which is expressible as
$$β = \frac{{\tilde{R}}_{1}^{- 1} {v}_{1}}{{v}_{1}^{H} {\tilde{R}}_{1}^{- 1} {v}_{1}}$$
wherein β is a conversion signal weight for the conversion signal, \tilde{R}₁ is the approximate matrix, and v₁ is a steering vector.

5. The beamformer according to claim 4, wherein the steering vector v₁ includes a steering vector that is converted by using at least one conversion function.

6. The beamformer according to claim 4, wherein the conversion signal weight includes a weight that is assigned to the at least one conversion function in order to compute an optimal value of the input signal weight.

7. The beamformer according to claim 4, wherein the weight computation processor includes a converter which is configured to compute the conversion signal by using an equation which is expressible as
u=V^{H}x
wherein u is a conversion signal, V is a conversion function, and x is an input signal.

8. The beamformer according to claim 4, wherein the at least one conversion function is configured with a combination of basis vectors which are obtainable by performing a principal component analysis for an optimal value of the input signal weight which is computed by using a minimum variance.

9. The beamformer according to claim 4, wherein the at least one conversion function reduces a number of dimensions of the input signal.

10. The beamformer according to claim 4, wherein the at least one conversion function is configured based on at least one orthogonal basis vector.

11. The beamformer according to claim 10, wherein the at least one orthogonal basis vector includes at least one from among an eigenvector and a Fourier basis vector.

12. A beamforming method comprising:
computing a covariance of a conversion signal which is obtainable by converting an input signal using at least one conversion function;
approximating the computed covariance to a Toeplitz matrix form;
computing an input signal weight which includes at least one from among a direct weight for the input signal and a conversion signal weight for the conversion signal based on a result of the approximating; and
generating an output signal using the computed input signal weight.

13. The beamforming method according to claim 12, wherein the approximating comprises computing an approximate matrix.

14. The beamforming method according to claim 13, wherein the computing the approximate matrix comprises using an equation which is expressible as
$${\tilde{R}}_{1 , m} = \frac{1}{L - m} {\sum }_{l = 1}^{L - m} {R}_{1 , l , l + m}$$
wherein m=0, 1, . . . , L−1, R_{1,l,l+m} represents an element in an l-th row and m-th column of a covariance R of the conversion signal, \tilde{R}_{1,m} is a value of an m-th diagonal of the approximate matrix, and L is a number of rows of the covariance R of the conversion signal.

15. The beamforming method according to claim 13, wherein the computing the input signal weight includes:
inverting the computed approximate matrix; and
computing the conversion signal weight by using a result of the inverting the computed approximate matrix.

16. The beamforming method according to claim 15, wherein the computing the conversion signal weight comprises using an equation which is expressible as
$$β = \frac{{\tilde{R}}_{1}^{- 1} {v}_{1}}{{v}_{1}^{H} {\tilde{R}}_{1}^{- 1} {v}_{1}}$$
wherein β is a weight, \tilde{R}₁ is the approximate matrix, and v₁ is a steering vector.

17. The beamforming method according to claim 12, wherein the at least one conversion function is configured with a combination of basis vectors which are obtainable by performing a principal component analysis for an optimal value of the input signal weight which is computed by using a minimum variance method.

18. A non-transitory computer readable medium having recorded thereon a program executable by a computer for performing a beamforming method, the method comprising:
computing a covariance of a conversion signal which is obtainable by converting an input signal using at least one conversion function;
approximating the computed covariance to a Toeplitz matrix form;
computing an input signal weight which includes at least one from among a direct weight for the input signal and a conversion signal weight for the conversion signal based on a result of the approximating; and
providing the computed input signal weight to a synthesizer which is configured for generating a signal using the computed input signal weight.

19. The non-transitory computer readable medium according to claim 18, wherein the approximating comprises computing an approximate matrix.

20. The non-transitory computer readable medium according to claim 19, wherein the computing the approximate matrix comprises using an equation which is expressible as
$${\tilde{R}}_{1 , m} = \frac{1}{L - m} {\sum }_{l = 1}^{L - m} {R}_{1 , l , l + m}$$
wherein m=0, 1, . . . , L−1, R_{1,l,l+m} represents an element in an l-th row and m-th column of a covariance R of the conversion signal, \tilde{R}_{1,m} is a value of an m-th diagonal of the approximate matrix, and L is a number of rows of the covariance R of the conversion signal.
